(19) United States
(12) Patent Application Publication
(10) Pub. No.: US 2003/0154375 A1
(43) Pub. Date: Aug. 14, 2003

(54) Universal crypto-adaptor system for supporting multiple APIs and multiple smart cards

(76) Inventor: Weimin Yang, Irvine, CA (US)

Correspondence Address: RAYMOND Y. CHAN, 1050 OAKDALE LANE, ARCADIA, CA, 91006, US

(21) Appl. No.: 10/071,738

(22) Filed: Feb. 8, 2002

(51) Int. Cl. H04L 9/00

(52) U.S. Cl. 713/172

(57) ABSTRACT

A universal crypto-adaptor system is adapted for supporting one or more smartcard applications with a plurality of smart cards through a smart card reader. The system includes an API unit for providing implementations of API specification for said smartcard applications, and a universal smart card API for communicating with said API means and said smart card reader for handling smart card operations including file and data managements and cryptographic operations, wherein said universal smart card comprises at least a smartcard translator to retrieve and translate smart card data saved in said respective smart card into a plurality of logic partitions that are compatible with each of said smartcard applications of said API means.

### BACKGROUND OF THE PRESENT INVENTION

1. Field of Invention

The present invention relates to an innovative cryptographic library, and more particularly to a universal crypto-adaptor system which supports the current most popular cryptographic APIs, such as CSP (Microsoft Cryptographic Application Interface) and PKCS11 (Cryptographic Token Interface Standard from RSA Security). Moreover, the present invention also supports multiple type tokens or smart cards, such as software tokens and hardware tokens.

2. Description of Related Arts

Smart card has the same size of credit card. It stores and processes information through the electronic circuits embedded in silicon in the plastic substrate of it body. Unlike magnetic stripe cards, smart cards carry both processing power and information. The physical appearance and properties of a smart card are defined in ISO 7816, which is the document of standard for the smart card industry.

Smart card uses the APDU (Application Protocol Data Units) to communicate with a host application. The APDU protocol, which is defined in ISO 7816-4, has two structures, namely a Command APDU which is used by the host application and a Response APDU which is used by the card. The APDU is sequence bytes. Smart card determines command from byte values.

Other smart cards include WPC, SCT, Java Card, and etc. Window Powered, Smartcard, WPC, uses the window smart card operation system. Microsoft provided another high level library to access card. There is no need to know the APDU commands. SCT is from Korean Smart Card Technology Company. Like most smart card, it uses the set of APDU commands to communicate with the card. Java card is a smartcard with java virtual machine which can executes the java byte code. There is no different from a normal smart card if you look from outside of the card. It uses the set of APDU commands to communicate with the card.

Generally, different card has different security policy, APDU commands and file system. It is not easy job to support a new card. You have to understand security policy. APDU commands and file system.

CSP and PKCS11 API Specifications contain very complicated mechanisms. CSP defines that the cryptographic operations can be only done in context. Context can be acquired in several different ways. The hashing, signing, encryption and decryption are performed and referenced by handles. PKCS11 defines the token, session concept, and PKCS objects. The cryptographic operations can only be done in session. It is more complicated than CSP. When developing a CSP or PKCS11 library for a specific smart card, company must spend lot money and resources to write code, debug and test.

Microsoft CAPI applications are developed by Microsoft and other compatible companies while the PKCS11 applications are developed by Netscape and some other compatible companies. WPC, SCT, Java Card and other smart cards are manufactured by respective companies. Cryptographic service provider (CSP) was defined by Microsoft on window system. A Cryptographic Service Provider (CSP) contains implementations of cryptographic standards and algorithms. At a minimum, a CSP consists of a dynamic-link library (DLL) that implements the functions in CryptoSPI (a System Program Interface). Most CSPs contain the implementation of all of their own functions; however, some CSPs implement their functions mainly in a Microsoft Win32-based service program managed by the Win32 writer must use, and the requirements that a CSP writer must fulfill to create a custom CSP. The cryptographic hashing and key are referenced as handle (number) in CSP. CSP must maintains all information and states. Generally CSP is very complicated specification and hard to implement.

PKCS11 (Public Key Cryptography Standard #11) was defined by RSA Security. It is Cryptographic Token Interface Standard. PKCS11 was intended from the beginning to be an interface between applications and all kinds of portable cryptographic devices, such as those based on smart cards, PCMCIA cards, and smart diskettes. PKCS11 provides an interface to one or more cryptographic devices that are active in the system through a number of “slot”. Each slot, which corresponds to a physical reader or other device interface, may contain a token. A token is typically “present in the slot” when a cryptographic device is present in the reader. PKCS11 defines three classes of object: data, certificates, and keys. A data object is defined by an application. A certificate object stores a certificate. A key object stores a cryptographic key. The key may be a public key, a private key, or a secret key, wherein each of these types of keys has subtypes for use in specific mechanisms.

Objects are also classified according to their lifetime and visibility. “Token objects” are visible to all applications connected to the token that have sufficient permission. and remain on the token even after the ‘sessions” (connections between an application and the token) are closed and the token is removed from its slot. “Session objects” are more temporary: whenever a session is closed by any means, all session objects created by that session are automatically destroyed. In addition, session objects are only visible to the application which created them. Further classification defines access requirements. Applications are not required to log into the token to view “public objects”; however, to view “private objects”, a user must be authenticated the token by a PIN or some other token-dependent method, such as a biometric device.

As shown in FIG. 1, to compare with conventional implementation of CSP and PKCS11 library, each CSP or PKCS11 library only support only support one type card. If a new type is needed to support, the completed individual library must be written for each token. As mentioned above, the CSP or PKCS11 contains very complicated mechanisms. It takes long time to implement. Therefore, it takes more money and resources to develop. Normally, CSP application cannot access the data created by PKCS11. In view of above, it is apparent that the CSP and the PKCS11 are very hard to implement.

### SUMMARY OF THE PRESENT INVENTION

A main objective of the present invention is to provide a universal crypto-adaptor system which not only supports various cryptographic APIs, including CSP (Microsoft Cryptographic Application Interface) and PKSD11 (Cryptographic Token Interface Standard from RSA Security), but also supports multiple type tokens or smart cards, including software tokens and hardware tokens.

Another objective of the present invention is to provide a universal crypto-adaptor system which can hide all physical smart card details and make that the API unit thinks it only deals with the same kind of smart card.

Another objective of the present invention is to provide a universal crypto-adaptor system which can translate all specific smart card commands into a universal smart card API, so as to significantly reduce the cost and production cycle.

Another objective of the present invention is to provide a universal crypto-adaptor system which isolates the connection between API Specification and the smartcard translator, so that when adding new API, the smartcard translator implementation is not required to do any changes, and when adding new smart card, the API implementation is not required to do any changes either. Therefore, it minimizes the cost for adding new API and token and development cycle. Once a component is tested, no more are needed in future. Therefore, it increases the productivities.

Another objection of the present invention is to provide a universal crypto-adaptor system for cryptographic library, wherein when a new smart card is introduced, the CSP or PKCS11 component doesn't know the difference and treat like before. Practically, only the smartcard translator (translator unit) needs to be written. Then, the CSP and PKCS11 components are no need to modify so as to save company money and resources.

In order to accomplish the above objectives, the present invention uses a total different approach to support multiple cards and multiple APIs. The present invention provides a universal crypto-adaptor system which comprises an API unit and a translator unit. The API unit comprises all implementations of API specification, including the CSP API unit which implements the CSP context and context policies and the PKCS API unit which implements the CSP session, crypto slot and PKCS object management, wherein when a smart card is inserted, the API unit negotiates with the smartcard translator unit. If the smart card doesn't support some operations or algorithms, the API unit will automatically do it on its own in software mode.

### BRIEF DESCRIPTION OF THE DRAWINGS

FIG. 1 is a block diagram illustrating the conventional implementation of CSP and PKCS11 library.

FIG. 2 is a block diagram according to a preferred embodiment of the present invention.

FIG. 3 is a block diagram illustrating a process of selecting the smartcard translator according to the above preferred embodiment of the present invention.

FIG. 4 is a block diagram illustrating how PKCS11 component determines who should do operation according to the above preferred embodiment of the present invention.

FIG. 5 illustrates a logic view of the universal smart card API file system according to the above preferred embodiment of the present invention.

FIG. 6 illustrates the conversion between data on the card and PKCS11 Object Attributes Array according to above preferred embodiment of the present invention.

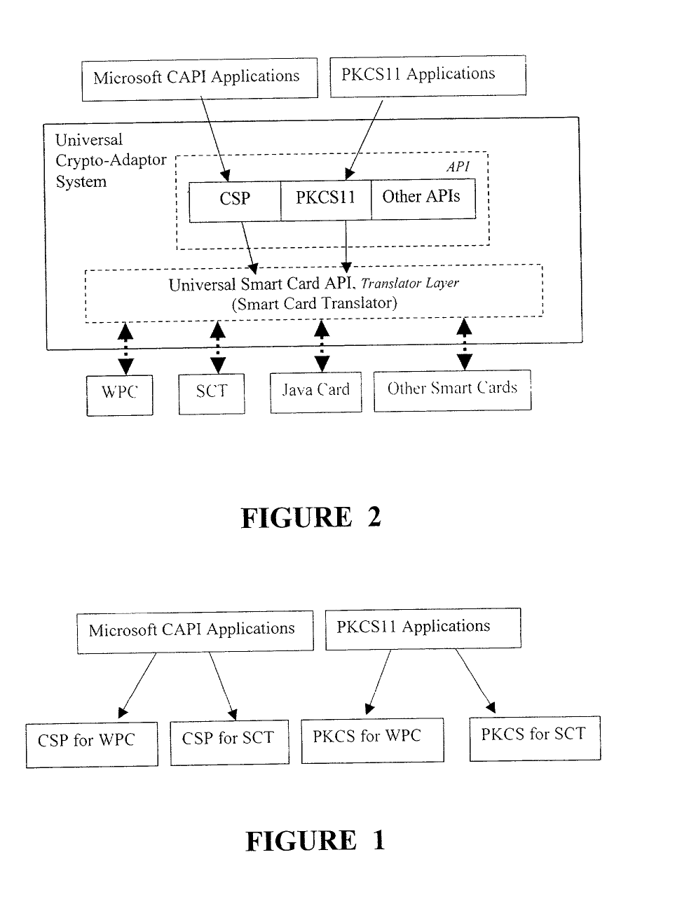

### DETAILED DESCRIPTION OF THE PREFERRED EMBODIMENT

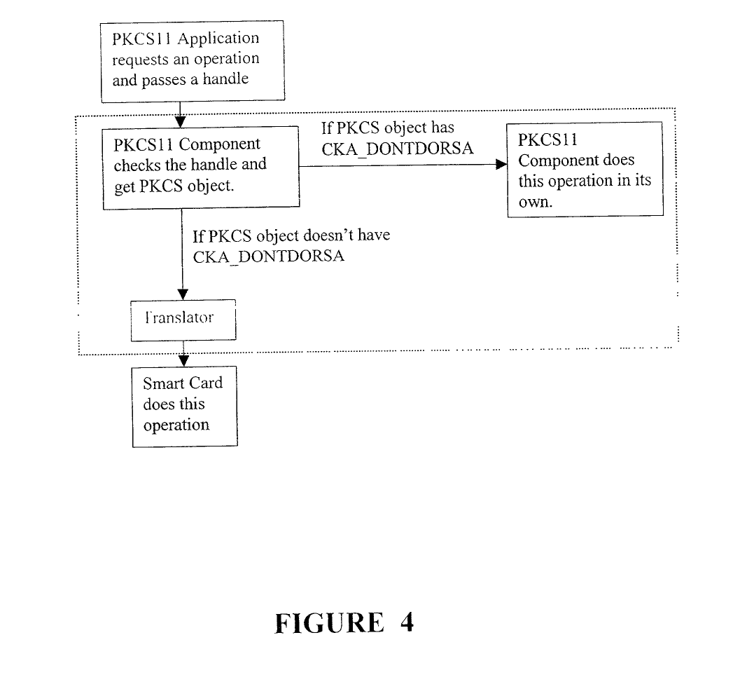

Referring to FIGS. 2 to 6 of the drawings, a universal crypto-adaptor system for cryptographic library according to a preferred embodiment of the present invention, which supports the current most popular cryptographic APIs, such as CSP (Microsoft Cryptographic Application Interface) and PKCS11 (Cryptographic Token Interface Standard from RSA Security). Moreover, the present invention also supports multiple type tokens or smart cards, such as software tokens and hardware tokens.

Referring to FIG. 2, the universal crypto-adaptor system generally comprises a API unit and a translator unit. The API unit contains all implementations of API specification, including CSP component and PKCS11 component. For instance, the CSP API specification implements the CSP context and context policies. The PKCS API specification implements the PKCS session, crypto slot and PKCS object management. If a smart card is inserted into a smart reader, the API unit communicates with the translator unit. If the smart card doesn't support some operations or algorithms, the API unit will automatically do it on its own in software mode.

According to the preferred embodiment, the translator unit further comprises a universal smart card API, which comprises at least a smartcard translator and provides the present invention a total different approach to support multiple smart cards and multiple APIs. Basically, the actual smart card difference is hidden by the universal smart card API.

When a new card is introduced, the CSP or PKCS11 component doesn't know the difference and treat like before. Only the smartcard translator (translator layer) needs to be written. Then, the CSP and PKCS11 components are no need to modify. It can save company money and resources.

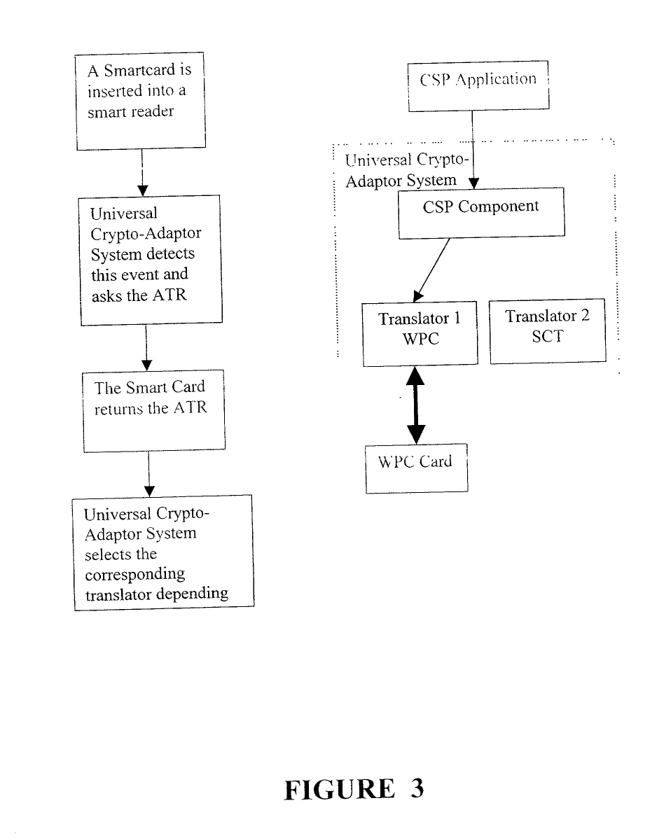

As shown in FIG. 3, according to the preferred embodiment, the universal smart card API comprises at least a WPC smartcard translator. a SCT smartcard translator, and a Java card smartcard translator with respect to the different types of smart card, including the WPC. SCT. Java Card. and etc.

Each smart card has its own identification number, which is ATR (Answer To Reset string). When a smart card is inserted into the smart card reader, the universal crypto-adaptor system asks the ATR from the smart card and selects the corresponding smartcard translator to use. A path from the smartcard application (such as the CSP application or the PKCS11 application) to the smart card is connected with a correct smartcard translator. FIG. 3 illustrates how the universal crypto-adaptor system of the present invention selects the corresponding smartcard translator with respect to the type of the smart card. Right side of the diagram is an example, which shows complete connection between, for example, the CSP application and the WPC card. PKCS application has very similar connection, just through PKCS component instead of CSP component.

The universal crypto-adaptor system of the present invention also supports some cryptographic operations which the smart card doesn't support. Due to the smart card computing power, it only supports the critical operations, such as RSA private key encryption or signing. Other operations, for examples, DES encryption and decryption, are done in the API unit. Some low end smart cards don't even support the RSA private key operation. The universal crypto-adaptor system defines a vendor PKCS object attribute, CKA_DONTDORSA. If this attribute is set, the API unit knows it doesn't do RSA private key operation and the API unit will do in its own in software.

The universal smart card API, which is a generic smart card interface that plays an important role in the present invention, covers file and data managements and cryptographic operations. It also considers the modem smart card technology, such as crypto on the card, multiple applications and multiple personalities. The smartcard application or library written above the universal smart card API can work with any other smart cards without any changes. It can help company reducing the smart card enabling software development cycle and saving cost.

The universal smart card API is an abstract interface for smart card. Theoretically, the universal smart card API can handle all smart cards operations. CSP or PKCS11 library calls the universal smart card API instead of calling each specific smart card interfaces. Implementing the smart card library using the universal smart card API is fairly simple than using PKCS and CSP APIs. As shown in FIG. 2, when adding a new API or smart card into library or application, just writing codes using the universal smart card API. Application can simply share data between the CSP and PKCS11 components.

Modern hardware technology can put 32 k or 64 k memory in a chip of the smart card so that a single smart card can store multiple applications or multiple identities data. such as health, credit and personal identification. The universal smart card API can handle such functions easily.

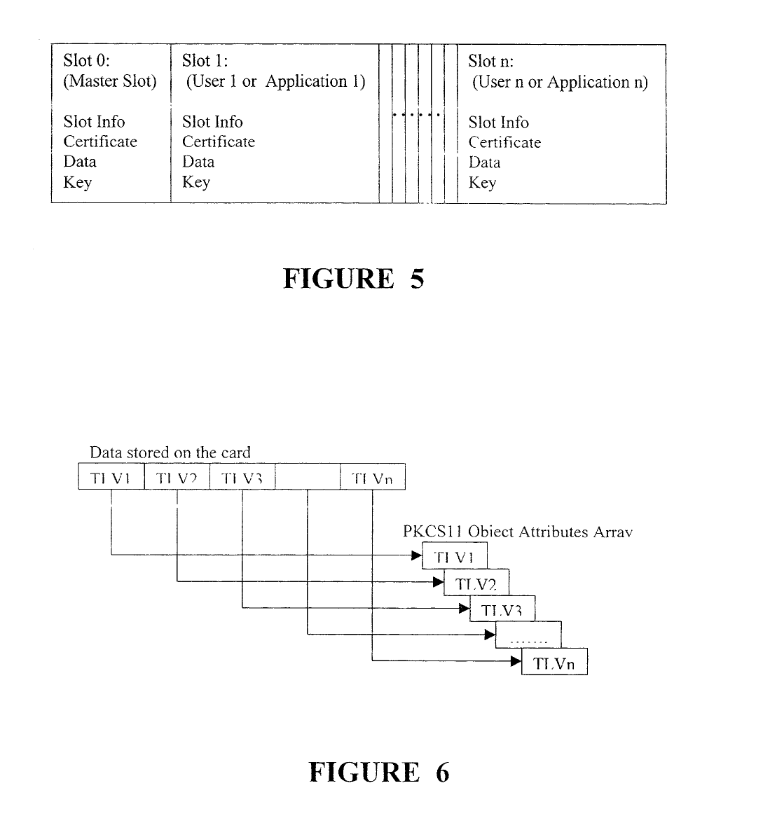

As shown in FIG. 5, the universal smart card API splits the data into the logic partitions. Each partition is a slot, wherein Slot 0 is a master slot, which contains the cardholder information. The rest each Slot is for each identity or application. For instance, Slot 1 data is for credit card. Slot 2 data is for health insurance. Generally, each slot has the same type data but different data.

The universal smart card API contains the various functions as follows:

(a) General functions, which contain APIs for card info and initialization.

DC_TOKENINFO is a data structure which has all info from card, such as label, manufacture, model and pin policy.

struct DC_TOKENINFO {

BYTE Label[32];

BYTE Manufacturer[32];

BYTE Model[16];

BYTE SerialNumber[16];

BYTE MaxPinLen;

BYTE MinPinLen;

CK_ULONG Flags;

CK_VERSION HardwareVersion;

CK_VERSION FirmwareVersion;

};

DCSC_GetTokenInfo gets the token info from the card. The caller must allocate memory for pInfo.

CK_RV DCSC_GetTokenInfo (OUT DC_TOKENINFO*pInfo);

DCSC_GetMechanismList gets the algorithms the card supports.

CK_RV DCSC_GetMechanismList (OUT CK_MECHANISM_TYPE*pMech,

OUT CK_ULONG*pMechCount);

DCSC_GetMechanismInfo gets the info for each supported mechanism.

CK_RV DCSC_GetMechanismInfo(IN CK_MECHANISM_TYPE MechanismList,

OUT CK_MECHANISM_INFO_PTR pInfo);

DCSC_TokenInit initializes the card with provided pin and label.

CK_RV DCSC_TokenInit (IN BYTE*pPIN, IN CK_ULONG PinLen, BYTE*pLabel,

CK_ULONG LabelLen);

(b) Slot management functions, which contain the slot creation, deletion and list.

DC_SLOTINFO has the slot pin policies and access policies.

struct DC_SLOTINFO {

BYTE MaxPinLen;

BYTE MinPinLen;

BYTE AccessLevel;

BYTE Flags;

};

DCSC_CreateSlot creates a slot for an application or personality.

CK_RV DCSC_CreateSlot (OUT DCSCHANDLE*pHSlot, IN DC_SLOTINFO*pSotInfo),

DCSC_DeleteSlot deletes the HSlot

CK_RV DCSC_DeleteSlot (IN DCSCHANDLE HSlot);

DCSC_GetSlotList gets the list from current card.

CK_RV DCSC_GetSlotList (OUT DCSCHANDLE*pHSlot, OUT CK_ULONG*pSlotCount);

DCSC_GetSlotInfo gets the slot info from HSlot.

CK_RV DCSC_GetSlotInfo (IN DCSCHANDLE HSlot, OUT DC_SLOTINFO*pSotInfo);

(c) Slot File list functions, which contain the functions to get the public and private file list. wherein public file list can be get without any authentication and private file list only can get retrieved after authentication, wherein the authentication method depends on the smart card.

DCSC_GetPublicFileList gets the public file list.

CK_RV DCSC_GetPublicFileList (IN DCSCHANDLE HSlot, CK_ATTRIBUTE*pList,

CK_ULONG& ListCount);

DCSC_GetPrivateFileList gets the private file list.

CK_RV DCSC_GetPrivateFileList (IN DCSCHANDLE HSlot, CK_ATTRIBUTE*pList.

CK_ULONG& ListCount);

(d) Authentication functions. which contain the login and logout. wherein the actual authentication method is implemented inside this function.

DCSC_Login passes the pin and user type to login for HSlot. User type can be either SO or user.

CK_RV DCSC_Login (IN DCSCHANDLE HSlot, IN DC_USER_TYPE UserType,

BYTE*pPIN, IN CK_ULONG PinLen);

DCSC_Logout log out the Hslot.

CK_RV DCSC_Logout (IN DCSCHANDLE HSlot);

(e) PIN management functions, which contain the change pin, init pin and unblock pin.

User can change his pin at Hslot.

CK_RV DCSC_changePIN (IN DCSCHANDLE HSlot, IN BYTE*pOldPIN,

IN CK_ULONG OldLen, IN BYTE*pNewPIN, CK_ULONG NewLen);

If the Hslot is not assigned pin, user can assign a pin to this HSlot.

CK_RV DCSC_InitPIN (IN DCSCHANDLE HSlot, IN BYTE*pPIN, CK_ULONG PinLen);

If the Hslot pin is blocked, user can unblock pin. Pin may be blocked after several bad pins tried.

CK_RV DCSC_UnblockPIN (IN DCSCHANDLE Hslot, IN BYTE*pUnblockedPIN,

IN CK_ULONG PinLen, IN BYTE*pNewPIN,

IN CK_ULONG NewLen);

(f) File Operation functions, which contain the data file related operations, wherein each smart card has a different way to access the file that pFileInfo has the info how to access file and pObject is a PKCS object which contain the data.

Create a File in Hslot.

CK_RV DCSC_CreateFile (IN DCSCHANDLE Hslot, OUT CK_ATTRIBUTE*pFileInfo,

IN PKCSObject*pObject);

Delete a File in Hslot.

CK_RV DCSC_DeleteFile (IN DCSCHANDLE HSlot, IN CK_ATTRIBUTE*FileInfo).

Update a File in Hslot.

CK_RV DCSC_UpdateFile (IN DCSCHANDLE HSlot, IN CK_ATTRIBUTE*FileInfo,

IN PKCSObject*pObject);

Read a file content from Hslot

CK_RV DCSC_ReadFile (IN DCSCHANDLE HSlot, IN CK_ATTRIBUTE*FileInfo,

OUT PKCSObject**pObject);

(g) Signing and verification functions, which include DCSC_Sign signs data using pMech mechanism and DCSC_Verify verifies the signature.

CK_RV DCSC_Sign (IN DCSCHANDLE HSlot, IN CK_MECHANISM*pMech,

IN CK_ATTRIBUTE*FileInfo, IN BYTE*pData,

IN CK_ULONG DataLen. IN OUT BYTE*pSignature,

OUT CK_ULONG*pSignLen),

CK_RV DCSC_Verify (IN DCSCHANDLE HSlot, IN CK_MECHANISM*pMech,

IN CK_ATTRIBUTE FileInfo, IN BYTE*pData, IN CK_ULONG DataLen,

IN BYTE*pSignature, IN CK_ULONG SignLen);

(h) Encryption and Decryption functions, which use a key file in HSlot.

CK_RV DCSC_Encrypt (IN DCSCHANDLE Hslot, IN CK_MECHANISM*pMech,

IN CK_ATTRIBUTE FileInfo, IN BYTE*pData,

IN CK_ULONG DataLen, IN OUT BYTE*pEncryptedData,

OUT CK_ULONG*pEncryptedLen, bool FinalState);

CK_RV DCSC_Decrypt (IN DCSCHANDLE Hslot, IN CK_MECHANISM*pMech,

IN CK_ATTRIBUTE*FileInfo, IN BYTE*pEncryptedData,

IN CK_ULONG EncryptedLen, IN OUT BYTE*pPlainText,

OUT CK_ULONG*pPlainTextLen, bool FinalState);

(i) Wrap and Unwrap key functions, which wrap and unwrap the symmetric key.

CK_RV DCSC_WrapKey (IN DCSCHANDLE Hslot, IN CK_MECHANISM*pMech,

IN CK_ATTRIBUTE WrappingFileInfo,

IN CK_ATTRIBUTE WrappedFileInfo,

IN OUT BYTE*pWrappedKey,

OUT CK_ULONG*pWrappedKeyLen);

CK_RV DCSC_UnwrapKey (IN DCSCHANDLE Hslot, IN CK_MECHANISM*pMech,

IN CK_ATTRIBUTE*WrappingFileInfo,

IN BYTE*pWrappedKey, IN CK_ULONG*pWrappedKeyLen,

OUT BYTE*pUnwrappedKey,

OUT CK_ULONG*pUnwrappedKeyLen,

OUT CK_ATTRIBUTE*pWrappedFileInfo);

(j) Digesting functions, which digest the data using pMech mechanism in Hslot.

CK_RV DCSC_Digest (IN DCSCHANDLE HSlot, IN CK_MECHANISM*pMech,

IN OUT CK_ATTRIBUTE FileInfo,

IN OUT BYTE*pData, IN OUT CK_ULONG DataLen, bool FinalState);

(k) Key Generation functions, which generate the symmetric key using DCSC_GenerateKey and asymmetric key using DCSC_GenerateKeyPair.

CK_RV DCSC_GenerateKey (IN DCSCHANDLE Hslot, IN CK_MECHANISM*pMech,

IN OUT CK_ATTRIBUTE*pFileInfo);

CK_RV DCSC_GenerateKeyPair (IN DCSCHANDLE Hslot, IN CK_MECHANISM*pMech,

IN OUT CK_ATTRIBUTE*pPrivFileInfo,

IN OUT CK_ATTRIBUTE*pPubFileInfo);

(l) Random Generation functions, which generate random number in HSlot.

Randome number generation in HSlot.

CK_RV DCSC_generateRandom (IN DCSCHANDLE HSlot, IN BYTE*pRandomdata,

OUT CK_ULONG*RandomLen);

The smart card has two different files, including a key file or password file for storing password or key data and a data file. The key file and password file cannot be retrieved or revealed.

The key file and password file are used to authenticate the user and protect other files. For example, some files are protected by one key file. One must provide the key so that the smart card can check against with card. If matched, the smart card OS indicates this file is never supposed to know the content of key and password files. You only can provide key or password checked against these files.

The data file is just the application data. The universal crypto-adaptor system of the present invention saves the data in TLV format (Type, Length and Value) on the card. TYPE is PKCS11 attribute type value. Length is the data length and value is the data value.

If is worth to mention that how the actual data stored in the smart card is different from card to card. It is determined by the card OS, wherein some use buffer and some use the file.

Different smart card has different mechanism to get data. WPC can enumerate the file and directory. When the universal crypto-adaptor system formats WPC, it creates several directories. Directory DCcert is used to store the certificate data. Directory DCkey is used to store the private key file. Directory DCdatal is used to store the public data file. Directory DCdata2 is used to store the private data file. DCcrypto will enumerate he file in these directories. After knowing the file name, the smartcard translator will send the get data APDU command to the card and get data.

### EXAMPLE

The Universal Crypto-Adaptor System Reads the Certificate from WPC.

1. The universal crypto-adaptor system enumerates the file in DCcert directory.

2. Foreach file

a. Issue ScwReadFileByName to get data

3. end

To get data from the private data file, there is little different. Before enumerating the file, the user must be authenticated.

The smartcard translator translates data into the universal crypto-adaptor system. As shown in FIG. 6, when data is retrieved from the smart card, the smartcard translator converts TLV into PKCS11 object attributes and creates the PKCS11 object. PKCS11 attribute is also in TLV fonnat so that the conversion is simply and effective.

The universal smart card system controls the visibility of data. When creating the PKCS11 object, the vendor defined attributes will attach in PKCS11 object.

The following table illustrates the universal crypto-adaptor system defined attributes.

| Attribute Name | Meaning |
|---|---|
| CKA_CSCONTATNERINFO | CSP Container Name |
| CKA_DONTDORSA | Card doesn't support this key operation |
| CKA_FILEINFO | File name on the card of this object |
| CKA_SLOTID | Slot ID of this object |

When smartcard application tries to access the data, the universal smart card API will check the attributes. If all conditions are satisfied, the universal smart card API will give it to outside.

When application uses the universal crypto-adaptor system of the present invention. The universal crypto-adaptor system first asks the smart card ATR and then loads the corresponding translator. The smarteard translator loads all public data and creates the CSP or PKCS11 objects. If user loges in, the smartcard translator will loads all private data. Now, the CSP and PKCS11 applications can use these data.

By means of the universal crypto-adaptor system as disclosed above, the present invention further comprises a method of incorporating a smart card with a cryptographic application, which comprises the steps of:

(1) checking for a smart card;

(2) requesting and receiving a smart card ATR from the smart card when the smart card is found;

(3) selecting a smartcard translator correspondingly, depending on the card ATR;

(4) searching public data on the smart card and creating a public application object correspondinly by the smartcard translator, such as a PKCS11 object or a CSP object;

(5) receiving a password from a smartcard application, such as CSP application or PKCS11 application, and sending the password to the selected smartcard translator for sending the password to the smart card for confirmation,

(6) searching private key object on the smart card and creating private application objects correspondingly by the smartcard translator, such as PKCS11objects or CSP objects;

(7) searching the private key object on the smart card for confirmation;

(8) receiving a function command with a private key object handle and data from the smartcard application by using the private key object handle and forwarding the data to the smart card with specifying a specific file name for executing a specific function, wherein the smartcard translator gets a CKA_FILEINFO attribute from the private key object so that the smartcard translator knows how to access a key file on the smart card; and

(9) receiving the data executed from the smart card and returning to the smartcard application.

For example, if the function is signing function, the above function command is a signing command and the data forwarded to said smart card from the smartcard application in the step (8) is signed by the smart card and returned to the smartcard application through the universal crypto-adaptor system of the present invention.

What is claimed is:

1. A universal crypto-adaptor system for supporting one or more smartcard applications with a plurality of smart cards through a smart card reader, comprising:
means for providing implementations of API specification for said smartcard applications; and
a universal smart card API for communicating with said API means and said smart card reader for handling smart card operations including file and data managements and cryptographic operations, wherein said universal smart card comprises at least a smartcard translator to retrieve and translate smart card data saved in said respective smart card into a plurality of logic partitions that are compatible with each of said smartcard applications of said API means.

2. The system, as recited in claim 1, wherein said smartcard applications include CSP (Microsoft Cryptographic Application Interface) applications and a PKCS11 (Cryptographic Token Interface Standard from RSA Security) applications.

3. The system, as recited in claim 2, wherein said smart cards include WPC card, SCT card and Java card.

4. The system, as recited in claim 3, wherein said API means includes a CSP component which is a CSP API specification that implements a CSP context and context policies and a PKCS11 component which is a PKCS API specification that implements a PKCS session, a crypto slot and a PKCS object management.

5. The system, as recited in claim 4, wherein said universal smart card API comprises at least a WPC smartcard translator, a SCT smartcard translator, and a Java card smarteard translator corresponding to said WPC card, said SCT card and said Java card respectively.

6. The system, as recited in claim 5, wherein said universal crypto-adaptor system further supports cryptographic operations, including a RSA private key encryption or signing and a DES encryption and decryption by defining a vendor PKCS object attribute, CKA_DONTDORSA.

7. The system, as recited in claim 1, wherein said universal smart card API splits said smart card data received from said smart cards into said logic partitions, wherein each of said partitions is a slot to store said smart card data of different information from said smart cards.

8. The system, as recited in claim 7, wherein universal smart card API includes at least a Slot 0 as a master slot that contains cardholder Information, a rest each Slot is for each identity or application, a Slot 1 for credit card data, and a Slot 2 for health insurance data. Generally, each slot has said same type data but different data.

9. The system, as recited in claim 6, wherein said universal smart card API splits said smart card data received from said smart cards into said logic partitions, wherein each of said partitions is a slot to store said smart card data of different information from said smart cards.

10. The system, as recited in claim 9, wherein universal smart card API includes at least a Slot 0 as a master slot that contains cardholder information, a rest each Slot is for each identity or application, a Slot1 for credit card data, and a Slot 2 for health insurance data. Generally, each slot has said same type data but different data.

11. The system, as recited in claim 6, wherein when said smart card data is retrieved from said smart card, said smartcard translator converts TLV into PKCS11 object attributes and creates said PKCS11 object while said PKCS11 object attribute is also in TLV format.

12. The system, as recited in claim 8, wherein when said smart card data is retrieved from said smart card, said smartcard translator converts TLV into PKCS11 object attributes and creates said PKCS11 object while said PKCS11 object attribute is also in TLV format.

13. The system, as recited in claim 10, wherein when said smart card data is retrieved from said smart card, said smartcard translator converts TLV into PKCS11 object attributes and creates said PKCS11 object while said PKCS11 object attribute is also in TLV format.

14. A method of incorporating a smart card with a cryptographic application, comprising the steps of:
(a) checking for a smart card;
(b) requesting and receiving a smart card ATR (Answer To Reset string) from said smart card when said smart card is found;
(c) selecting a smartcard translator correspondingly, depending on said card ATR;
(d) searching public data on said smart card and creating a public application object correspondinly by said smartcard translator, such as a PKCS11 object or a CSP object;
(e) receiving a password from a smartcard application, such as CSP application or PKCS11 application, and sending said password to said selected smartcard translator for sending said password to said smart card for confirmation;
(f) searching private key object on said smart card and creating private application objects correspondingly by said smartcard translator;
(g) searching said private key object on said smart card for confirmation;
(h) receiving a function command with a private key object handle and data from said smartcard application by using said private key object handle and forwarding said data to said smart card with specifying a specific file name for executing a specific function, wherein said smartcard translator gets an attribute from said private key object so that said smartcard translator knows how to access a key file on said smart card; and
(i) receiving said data executed from said smart card and returning to said smartcard application.

15. The method, as recited in claim 14, wherein when said function is signing function, said function command is a signing command and said data forwarded to said smart card from said smartcard application in the step (h) is signed by said smart card and returned to said smartcard application through said universal crypto-adaptor system.

16. The method, as recited in claim 14, further comprising a step of saving said data in a “Type, Length and Value” (TLV) format.
